(19) United States
(12) Patent Application Publication
(10) Pub. No.: US 2004/0267168 A1
(43) Pub. Date: Dec. 30, 2004

(54) Method and apparatus for balancing electric potential of human body

(76) Inventor: Kuo-Wei Feng, Taipei City (TW)

Correspondence Address: BACON & THOMAS, PLLC, 625 SLATERS LANE, FOURTH FLOOR, ALEXANDRIA, VA, 22314

(21) Appl. No.: 10/606,743

(22) Filed: Jun. 27, 2003

(51) Int. Cl. A61H 7/00

(52) U.S. Cl. 601/15; 601/21; 601/134; 607/148; 607/149

(57) ABSTRACT

The method and apparatus for balancing the electric potential of a human body takes advantage of pressing to arouse the force and latent power of self-treatment by electric current of the human body. The method mainly is done by pressing the abdomen and the buttocks to make the human body generate regular respiration whereby positive and negative ions in the nature are absorbed and delivered by the blood and the nerve system for circulation to make complement and get a balanced effect with the positive and negative ions in the cell tissues in the nerve system of the human body. The apparatus is provided mainly on a base with massage mechanisms, by pressing the vital points on the abdomen and the buttocks periodically for predetermined times with the massage mechanisms, and by the images shown, the user can totally pay attention to the area where the electric current flows through to promote balancing of the positive and negative ions to get the effect of removing diseases and making good health.

### BACKGROUND OF THE INVENTION

1. Field of the Invention

The present invention is related to a method and apparatus for balancing the electric potential of a human body, and especially to a method and apparatus for pressing to promote the self-treatment reaction of the electric current in a human body and arouse the force and latent power of self-treatment by electric current of the human body through the nerve system, blood vessel system, self-control nerve system as well as vein and lymph systems.

2. Description of the Prior Art

In the year of 1983, Dr. Bjorm Nor-Denstrom of Sweden disclosed “The electric current and electromagnetic field in the closed electric circuits of a human body forms by itself a small cosmos” in a book (Biologically Closed Electric Circuits: Clinical Experimental And Theoretical Evidence For An Additional Circulatory System) to testify that there are electric current and closed electric circuits in a human body.

The thesis mentioned that the action of the electric current in a human body is quite similar to the situation of occurrence of electric current in a battery; there are various mineral elements in the cell tissues in the human body, such as idiom and potassium, the atoms of them are all born with electric charges, they may release ions with positive and negative electric charges when they are stimulated to generate electric current in the human body, the electric current is delivered to the cerebrum of the human body. That is to say, when some tissue of the human body is hurt or when muscles move, the cells at the spot of stimulation will generate ions with positive electric charges, and the cells in the neighboring tissues being spaced from the spot will relatively generate ions with negative electric charges, the positive and the negative poles may generate electric current just like the situation of the closed electric current of a battery.

The electric current generated in the human body takes the blood vessels as its insulation conduits, takes the cell envelopes of the capillary blood vessels as electrodes, the intermediate tissues as barriers for permeation of micro-particles (such as the barrier of a battery), the blood plasmas as the conductors of electric current. The cell envelopes of the capillary blood vessels are natural electrodes for bearing electric charges; the enzymes in the cells bear metallic mineral elements such as active sodium and potassium etc., they often discharge electrons and particles able to permeate the extreme fine holes of the cell envelopes. Once they are stimulated, they react and make exchange, groups of electrons pass through the bridging conductors formed by the enzymes and flow to the other side to form the closed electric current and an electromagnetic field, they are limited in the cells to flow locally.

The reaction of the capillary blood vessels of veins to electric current is somewhat different from that of arteries; the capillary blood vessels of veins do not close their extreme fine holes when they are hurt and stimulated by electric current. White corpuscles permeate outwards through the fine holes that are still opened, because they bear negative electric charges, and will be attracted by the positive electric charges outside. And stimulation can induce oscillation of electric energy to form electric current running in the type of a spider web; the white corpuscles and the electric current run toward the tissues urgently need them to destruct intruding germs, this is the self-treatment reaction of the electric current of a human body. In other words, the capillary blood vessels of veins release white corpuscles, suprarenal glands releases hormones, and pineal glands releases Endorthine hormones to relieve pain; these were published on the cover page of the “New Discovery of Science” monthly magazine of March 1986 in the U.S.A. and introduced as the headline news of the testament of the theory that human bodies have electric currents and electromagnetic fields.

In other words, according to the above theory, when the positive and negative electric charges are in the state of instability, some disease may be induced in the human body, and this is the cause of disease of the human body; and the best way to relieve the cause of disease is to make balancing between the positive and negative electric charges in the human body, then the human body can get better and can be kept in the best state.

### SUMMARY OF THE INVENTION

In view of the above statement, the inventor of the present invention developed the method and apparatus for balancing the electric potential of a human body based on his professional experience of years in studying and developing as well as repeated experiments and tests, in order to get rid of the non-balanced state between the positive and negative electric charges in a human body through the method and apparatus for balancing the electric potential of the human body.

The method and apparatus for balancing the electric potential of a human body of the present invention is operated to press the areas of the abdomen and the buttocks to render the human body to generate regular respiration whereby positive and negative ions in the nature are absorbed and are delivered by the blood and the nerve system for circulation to make complement and get a balanced effect with the positive and negative ions in the cell tissues in the nerve system of the human body. The apparatus is provided mainly on a base with massage mechanisms, by pressing the vital points on the areas of the abdomen and the buttocks periodically for predetermined times with the massage mechanisms, the action that the positive and negative ions released from the cell tissues in the nerve system of the human body make mutual attraction with the positive and negative ions existing in the nature can balance the electric charges in the human body; in other words, when some electric charges in the human body (positive or negative electric charges) are increased, they may make interaction with the electric charges existing in the nature to balance the electric charges in the human body and thereby to make the human body with a disease get better.

The object of the present invention is: by pressing the vital points on the areas of the abdomen and the buttocks periodically for predetermined times with a massage apparatus, the positive and negative ions in the human body attract the positive and negative ions existing in the nature to achieve the effect of balancing, and thereby to relieve the cause of a disease of the human body.

Another object of the present invention is to provide a massage apparatus which has massage mechanisms provided respectively at suitable areas at the abdomen and the buttocks of the human body, by pressing of a massage portion moved by a force exerting unit on the abdomen and the buttocks, the human body can generate regular respiration to absorb positive and negative ions existing in the nature to get balance of the positive and negative ions in the cell tissues in the nerve system of the human body.

The present invention will be apparent in its content and the effects to be achieved after reading the detailed description of the preferred embodiment thereof in reference to the accompanying drawings.

### BRIEF DESCRIPTION OF THE DRAWINGS

FIG. 1 is a schematic view showing exchange of electric current in the present invention;

FIG. 2 is a schematic view showing the electric current in a human body;

FIG. 3 is a side view of the present invention;

FIG. 4 is a perspective schematic view of the present invention;

FIG. 5 is a sectional view of a massage mechanism of the present invention;

FIG. 6 is a perspective view of another embodiment of massage mechanism of the present invention;

FIG. 7 is a schematic view of another embodiment the massage apparatus of the present invention.

### DETAILED DESCRIPTION OF THE PREFERRED EMBODIMENT

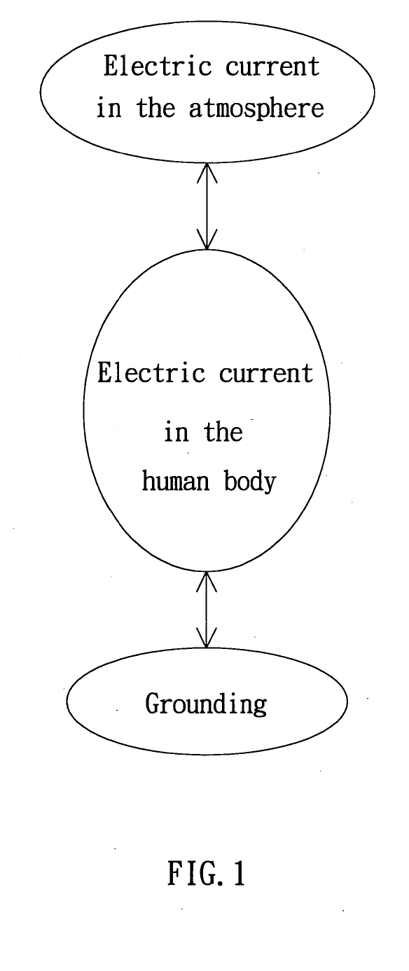

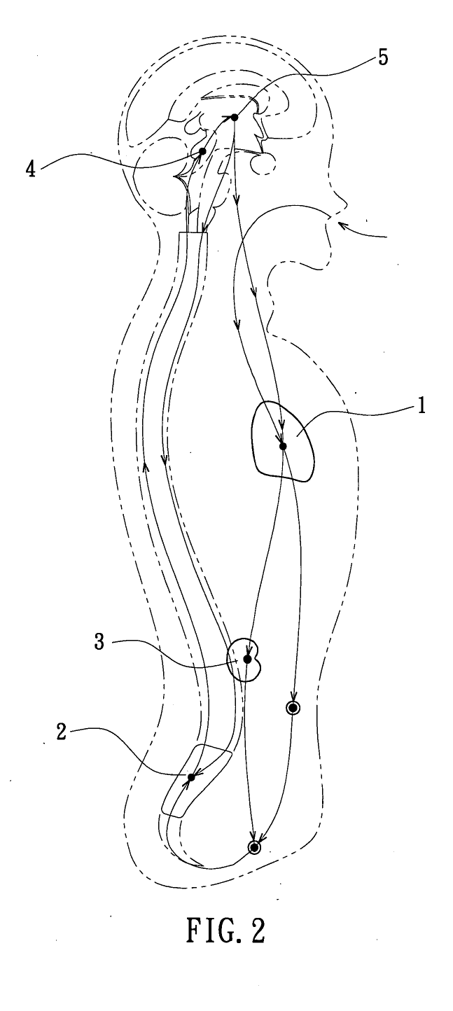

Referring firstly to FIGS. 1 and 2, the method and apparatus for balancing the electric potential of a human body of the present invention takes advantage of the electric current in the human body as a medium from the electric current generated between the atmosphere and the ground, to make absorption and discharging in the way of natural respiration and by delivery and circulation of the blood vessel system, nerve system as well as vein and lymph systems of the human body, to make exchange and convection of the positive and negative ions in the cell tissues in the nerve system of the human body with the positive and negative ions in the nature to get a balancing of the positive and negative ions.

The method of balancing is done by pressing the vital points on the areas of the abdomen and the buttocks with the massage apparatus, and by absorbing the positive and negative ions in the nature (atmosphere) with the natural respiration system of the human body, to render the positive and negative ions to flow through the five main passages of the human body by circulation and bringing of the blood (the blood bears therein positive electric charges, while the cells of the blood vessels bear negative electric charges), namely, through the important passages including the center of the heart 1 (that is the opening to the heart or “Hsinchiao” so called by Chinese herb doctors), the socrum 2 (one of the vertebrae), the nerve plexus 3 at the joint of the artery and the vein between the two kidneys (that is the opening to the kidney or “Shenchiao” so called by Chinese herb doctors), the fourth ventricle of brain 4 (that is the key path or “Hsuankuan” so called by Chinese herb doctors), the third ventricle of brain 5 in the head of the human body (that is the inspiration spot or “Lingtai” so called by Chinese herb doctors) etc., so that the human body forms therein circulating electric current to make mutual complement for the positive and negative ions which are lacked normally in the cell tissues in the nerve system of the human body, thereby balancing of electric potential can be achieved.

The above stated circulating electric current formed in a human body is used to adjust balance of the positive and negative ions in the cell tissues in the nerve system of the human body through the vertebrae of the human body, hence when the electric current flows through the vertebrae to make balancing of the positive and negative ions in the cell tissues in the nerve system of the vertebrae, diseases in the vertebrae can be reduced. By virtue that actions of the nerve system in a human body are controlled by the vertebrae; i.e., balance of the positive and negative ions in the cell tissues in the nerve system of the human body can effectively obtain the effect of getting rid of the diseases through making balancing of the positive and negative ions in the cell tissues in the entire human body via the whole network of the human body.

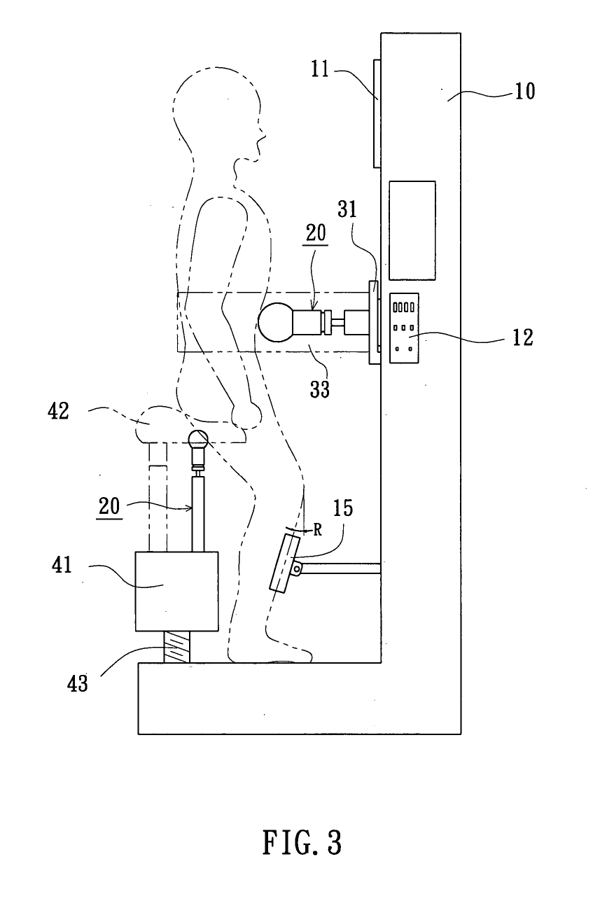

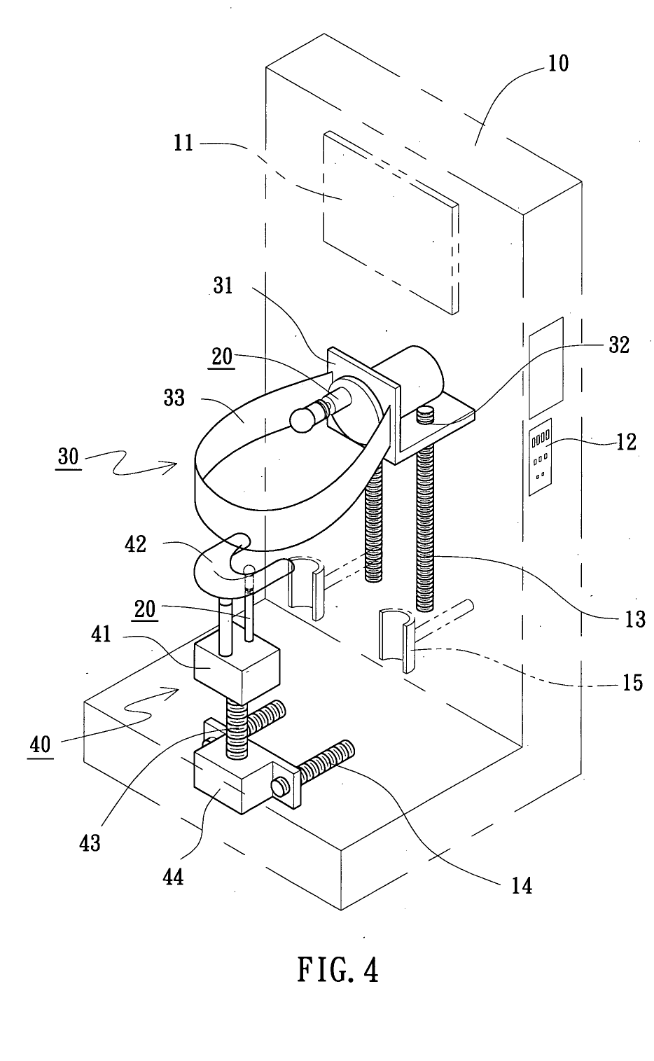

As shown in FIGS. 3 and 4, the apparatus for balancing the electric potential of a human body of the present invention comprises mainly a base 10 and at least a set of massage mechanism 20.

Wherein: the base 10 receives thereon the massage mechanisms 20; and is provided at a position in opposition to the viewing position of the user with a display 11, and on one side thereof with a control panel 12 able to control the massage mechanisms 20, and further at a position in opposition to the massage mechanisms 20 with a plurality of first adjustment elements 13 and second adjustment elements 14 respectively.

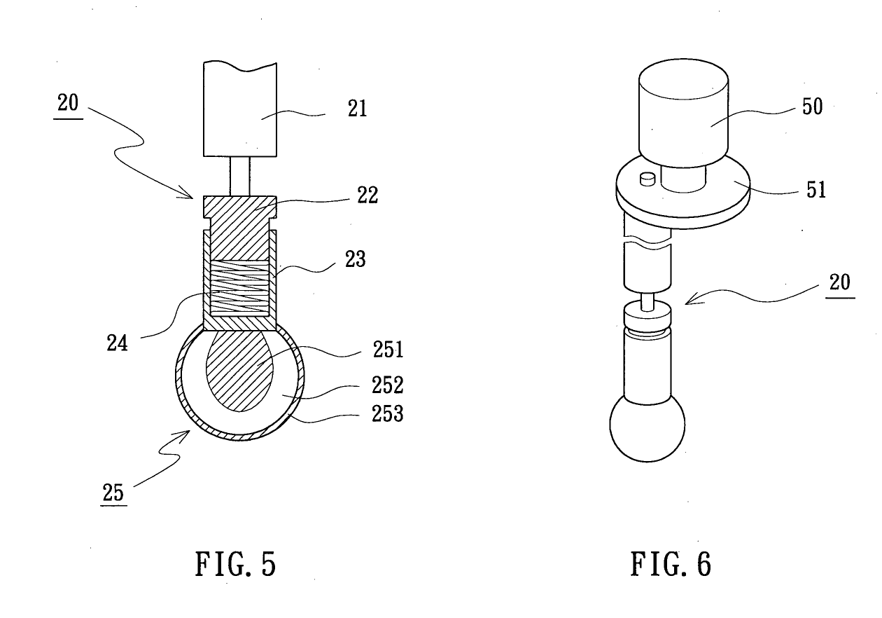

And also referring to FIG. 5, a massage mechanism 20 is composed of a force exerting unit 21, a guide portion 22, a linking-up portion 23, an elastic element 24 and a massaging portion 25; the force exerting unit 21 is connected with the guide portion 22 of which the front end is provided with the linking-up portion 23, the guide portion 22 and the linking-up portion 23 are provided there between with the elastic element 24, the linking-up portion 23 is provided on the front end thereof with the massaging portion 25 that includes a pressing head 251 enveloped with a sponge 252, the sponge 252 is further enveloped with an outer envelopment 253, action of the force exerting unit 21 can render the massaging portion 25 to get the effect of pressing.

In practicing the present invention on an upright massage apparatus, a massage mechanism 20 is provided on one side of the base 10 (in opposition to the position of the abdomen of the user) and provided fixedly on a plate 31 to form a first massage mechanism 30 for pressing the abdomen of the user. The plate 31 has a screw hole 32 screw connecting with the first adjustment elements 13 on the base 10, so that the plate 31 can be moved by the first adjustment elements 13 for displace up and down. The plate 31 is provided thereon with a restraining belt 33 for slipping over the waist of the user to make steady of the user, thereby the first massage mechanism 30 can push the guide portion 22 to compress the elastic element 24 by the action of the force exerting unit 21, thereby the linking-up portion 23 can be restored by the elastic function of the elastic element 24. Then the massaging portion 25 can be activated to periodically press appropriately the abdomen of the user; thereby the massage mechanism 20 can make effective pressing action on the abdomen.

Relatively, when a massage mechanism 20 is provided on the floor surface of the base 10 to form a second massage mechanism 40 that is provided on a movable platform 41 able to move up and down, the second massage mechanism 40 is provided thereon with a changeable seat 42 at a suitable position; the movable platform 41 is moved up and down by a bolt 43 as a displacing element to adjust the height of the seat 42. The other end of the bolt 43 is connected to a platform 44 which is displaced by the second adjustment elements 14 provided on the floor of the base 10, so that the second massage mechanism 40 makes adjustment frontwards and rearwards, and the massage mechanism 20 can make effective pressing action on the buttocks, thereby (the base 10 is provided simultaneously with the first massage mechanism 30 and the second massage mechanism 40).

And the first massage mechanism 30 is provided thereunder on the base 10 with a pair of brackets 15 for leaning of legs of the user, the brackets 15 render the legs of the user to lean on them in suitable angles (such as the angle “R” shown in FIG. 3, so that the second massage mechanism 40 can do pressing action more effectively on the buttocks of the user.

And referring to FIG. 6, the massage mechanism 20 further can be rotated by moving of a transmitting mechanism 50; a driving element 51 is provided between the massage mechanism 20 and the transmitting mechanism 50, the center of the massage mechanism 20 is eccentrically located on the driving element 51, so that the massage mechanism 20 can rotate around the driving element 51.

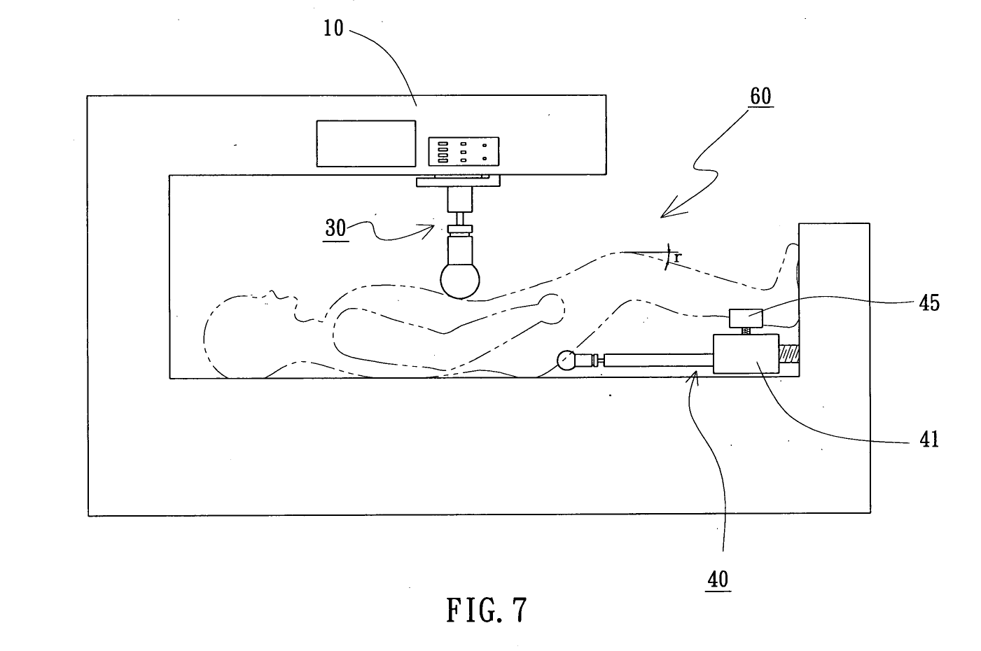

As shown in FIG. 7, when the present invention is practiced on a laid down massage apparatus, the first massage mechanism 30 extends down from the base 10 to be located at a position corresponding to the position of the abdomen of the user, at this time, the back of the user can lye on the base 10 without leaning on a restraining belt, while the second massage mechanism 40 is provided at a position corresponding to that of the buttocks of the user, and the movable platform 41 is provided thereon with a foot bracket 45 able to move upwards and downwards, so that the user can have his knees bent for an angle (“r” as shown in the drawing) by bracing of the foot bracket 45. Thereby the second massage mechanism 40 can do effective pressing action on the abdomen and the buttocks of the user as is the case on the above stated upright massage apparatus.

Referring to FIGS. 2, 3 and 4, the massage apparatus achieves balancing of the positive and negative ions in the cell tissues in the nerve system of the human body mainly by pressing the vital points on the areas of the abdomen and the buttocks with the first massage mechanism 30 and the second massage mechanism 40 to render the human body to generate regular respiration whereby positive and negative ions in the nature are absorbed and are delivered by the blood and the nerve systems as well as vein and lymph systems for circulation to render the positive and negative ions to flow through the five main passages of the human body, namely, through the important passages including the center of the heart 1 (that is the opening to the heart or “Hsinchiao” so called by Chinese herb doctors), the socrum 2 (one of the vertebrae), the nerve plexus 3 at the joint of the artery and the vein between the two kidneys (that is the opening to the kidney or “Shenchiao” so called by Chinese herb doctors), the fourth ventricle of brain 4 (that is the key path or “Hsuankuan” so called by Chinese herb doctors), the third ventricle of brain 5 in the head of the human body (that is the inspiration spot or “Lingtai” so called by Chinese herb doctors) etc.

In addition to this, the display 11 on the massage apparatus is used to display the moving images from the electric current of the human body, in order that the user can totally pay attention to the area where the electric current flows through to increase the effect of coordination of the positive and negative ions at this area, thereby to promote balancing of the positive and negative ions to get the effect of removing diseases and making good health.

When in pressing the vital points on the areas of the abdomen and the buttocks with the massage apparatus, for increasing the effect of pressing, the user can have his knees bent for an angle in a natural state (about 15-35 degrees, it is exactly the angle “R” shown in FIG. 3), the goal of this is to make the human body be in the best relax state, so that the electric current can flow smoothly through every part of the human body. And the number of times of pressing can be 19, 29 or 39 in a circulation period, in order that the situation of the human body in such a circulation period can be moderately adjusted, due amount of pressing can be added to the human body in pursuance of the requirement of an individual person to get the largest balancing effect.

Further, according to the above stated principle of action of electric current, when a user uses the massage apparatus of the present invention, he shall use with his belly empty, and shall make his feet bare; only in this mode, the user can make electric grounding of the massage apparatus, and electric current can be transmitted all over the human body to promote circulation of the electric current.

The names of the members composing the present invention are only for illustrating a preferred embodiment of the present invention, and not for giving any limitation to the scope of the present invention. It will be apparent to those skilled in this art that various equivalent modifications or changes made to the elements of the present invention without departing from the spirit shall fall within the scope of the appended claims.

1. A method for balancing the electric potential of a human body, said method includes the process of pressing vital points on an abdomen and buttocks of a human body to render said human body to absorb positive and negative ions in the nature in a natural mode of respiration, so that electric current in said human body flows by bringing of blood (said blood bears therein positive electric charges, while cells of blood vessels bear negative electric charges) through the center of the heart, the socrum, a nerve plexus at the joint of an artery and a vein between two kidneys, the fourth ventricle of brain, the third ventricle of brain in the head of said human body etc. to achieve an effect of balancing of said positive and negative ions in cell tissues in the nerve system of said human body with said positive and negative ions in the nature and to thereby relieve the cause of diseases of said human body.

2. The method as in claim 1, wherein when in pressing said vital points on said abdomen and said buttocks of said human body, bending angle of the knees of said user is 15-35 degrees to make said human body be in the best relax state.

3. The method as in claim 1, wherein the number of times of pressing is 19, 29 or 39 in a circulation period, in order that situation of said human body in such a circulation period is moderately adjusted, due amount of pressing added to said human body is taken in pursuance of the requirement of said human body.

4. An apparatus for balancing the electric potential of a human body, said apparatus comprises a base and at least a set of massage mechanism, wherein:
said base receives thereon said massage mechanisms;
each of said massage mechanisms is composed of a force exerting unit, a guide portion, a linking-up portion, a massaging portion and an elastic element; said force exerting unit is connected with said guide portion of which the front end is provided with said linking-up portion, said guide portion and said linking-up portion are provided therebetween with said elastic element, said linking-up portion is provided on the front end thereof with said massaging portion.

5. The apparatus as in claim 4, wherein said massaging portion includes a pressing head enveloped with a sponge, said sponge is further enveloped with an outer envelopment.

6. An apparatus as in claim 4, wherein said massage mechanism further is moved by moving of a transmitting mechanism; a driving element is provided between said massage mechanism and said transmitting mechanism.

7. The apparatus as in claim 6, wherein the center of said massage mechanism is eccentrically located on said driving element.

8. The apparatus as in claim 4, wherein said base is provided at a position in opposition to said massage mechanisms with a plurality of first adjustment elements and second adjustment elements respectively.

9. The apparatus as in claim 8, wherein one of said massage mechanisms is provided on one side of said base and provided fixedly on a plate to form a first massage mechanism, said plate has a screw hole screw connecting with said first adjustment elements on said base, so that said plate is moved by said first adjustment elements for displacing up and down.

10. The apparatus as in claim 9, wherein said plate is provided thereon with a restraining belt to make steady of the waist of said user the user.

11. The apparatus as in claim 8, wherein another one of said massage mechanisms is provided on a floor surface of said base to form a second massage mechanism that is provided on a movable platform able to move up and down, said movable platform is moved up and down by a bolt as a displacing element, the other end of said bolt is connected to a platform which is displaced by said second adjustment elements provided on said floor of said base.

12. The apparatus as in claim 11, wherein said second massage mechanism is provided thereon with a changeable seat.

13. The apparatus as in claim 4, wherein said base is provided with a display.

14. The apparatus as in claim 13, wherein said base is provided on one side thereof with a control panel able to control said massage mechanisms.

15. The apparatus as in claim 4, wherein said massage apparatus is a laid down massage apparatus.

16. The apparatus as in claim 15, wherein said laid down massage apparatus is provided on said movable platform of said second massage mechanism with a foot bracket adapted to moving upwards and downwards.

17. The apparatus as in claim 4, wherein said first massage mechanism is provided thereunder on said base with a pair of brackets.
